(19) United States
(12) Patent Application Publication
(10) Pub. No.: US 2026/0341238 A1
(43) Pub. Date: Oct. 29, 2026

(54) DISPLAY PANEL, BRIGHTNESS CONTROL METHOD THEREOF, AND DISPLAY DEVICE

(71) Applicant: HKC CORPORATION LIMITED, Shenzhen (CN)

(72) Inventors: Yuanchan Wang, Shenzhen (CN); Xianyu Wang, Shenzhen (CN); Min Guo, Shenzhen (CN); Mengling Wang, Shenzhen (CN); Xingzhen Gong, Shenzhen (CN); Pei Xu, Shenzhen (CN)

(21) Appl. No.: 19/548,975

(22) Filed: Feb. 25, 2026

(30) Foreign Application Priority Data
Feb. 28, 2025 (CN) 202510236226.X

(51) Int. Cl. G09G 3/34; G02F 1/133; G06F 3/041; G09G 3/36

(52) U.S. Cl. CPC G09G 3/3406; G02F 1/13318; G06F 3/0412; G06F 3/0418; G09G 3/3648; G09G 2320/0626; G09G 2354/00; G09G 2360/14

(57) ABSTRACT

A display panel, a brightness control method thereof, and a display device are disclosed. The display panel includes a mode recognition module, a determination module, and a brightness adjustment module. When the display panel enters a landscape mode, if photosensors within a part of the photosensitive regions on each of the first side and the second side of the display panel are simultaneously occluded, the display panel is determined to be in a false touch state and a false touch signal is generated. Upon receiving the false touch signal, the brightness adjustment module maintains the brightness of the display panel unchanged. The first side and the second side of the display panel correspond to the left and right sides, respectively, when the display panel is in landscape mode.

### CROSS-REFERENCE TO RELATED APPLICATIONS

This application claims the priority and benefit of Chinese patent application number 202510236226X, titled "Display Panel, Brightness Control Method Thereof, and Display Device" and filed Feb. 28, 2025 with China National Intellectual Property Administration, the entire contents of which are incorporated herein by reference.

### TECHNICAL FIELD

The present application relates to the field of display technologies, and more particularly relates to a display panel, a brightness control method thereof, and a display device.

### BACKGROUND

The description provided in this section is intended for the mere purpose of providing background information related to the present application but does not necessarily constitute prior art.

With the development of display technologies, liquid crystal display panels (LCDs) have become increasingly popular due to their advantages such as light weight and low radiation. An LCD panel includes an array substrate and a color filter substrate that are disposed opposite to each other, and a liquid crystal layer disposed therebetween. By controlling the rotation of the liquid crystals, brightness adjustment can be achieved. LCD panels may be provided with a photosensor to detect ambient light brightness. The display brightness of the LCD panel is then adjusted based on the detected ambient brightness to meet user requirements.

In related display products with automatic brightness adjustment technologies, the ambient light sensors may be disposed at the upper and lower edges of the display screen, where they are prone to being blocked during use. For example, in gaming scenarios in the landscape mode, the user's fingers may block the upper or lower edge of the screen, causing the ambient light sensor to receive incorrect ambient light change amount and leading to erroneous brightness adjustment, which may result in screen dimming and affect use. In other scenarios where only the ambient light sensor is blocked, the screen may also adjust brightness incorrectly.

### SUMMARY

An objective of the embodiment of the present application is therefore to provide a display panel, a brightness control method thereof, and a display device, so as to prevent erroneous brightness adjustment caused by accidental touches during use of the display product, thereby improving the user experience.

Embodiments of the present application disclose a display panel. A display region of the display panel is divided into a plurality of photosensitive regions arranged in an array. Each side of the display panel includes a plurality of photosensitive regions, and at least one photosensor is disposed in each photosensitive region. The display panel includes a mode recognition module, a determination module, and a brightness adjustment module. The mode recognition module is configured to identify a display mode of the display panel. The determination module is coupled to the mode recognition module, photosensors within all the photosensitive regions on the first side of the display panel, and photosensors within all the photosensitive regions on the second side of the display panel. When the display panel enters a landscape mode, if the photosensors in part of the photosensitive regions on both the first side and the second side are simultaneously blocked, the display panel is determined to be in a false touch state, and a false touch signal is generated. The brightness adjustment module is configured to adjust the brightness of the display panel. The brightness adjustment module is coupled to the determination module. When the false touch signal is received, the brightness adjustment module maintains the brightness of the display panel unchanged. The first side and the second side of the display panel respectively refer to the left and right sides of the display panel when it is in the landscape mode.

Embodiments of the present application further disclose a brightness control method for a display panel, which is configured to control the brightness of the above-described display panel. A display region of the display panel is divided into a plurality of photosensitive regions arranged in an array, wherein each side of the display panel includes a plurality of photosensitive regions, and wherein there is disposed at least one photosensor in each photosensitive region. The brightness control method includes the following operations:
obtaining a display mode of the display panel;
when it is detected that the display panel enters a landscape mode, simultaneously detecting whether multiple photosensors in the photosensitive regions located on the first side and the second side of the display panel are blocked; and
when it is detected that a part of the photosensors in the photosensitive regions on both the first side and the second side of the display panel are simultaneously blocked, determining that the display panel is in a false touch state and maintaining the brightness of the display panel unchanged.

Embodiments of the present application further disclose a display device. The display device includes a driving circuit and a display panel, where the driving circuit is configured to drive the display panel. The display region of the display panel is divided into a plurality of photosensitive regions arranged in an array. Each side of the display panel includes multiple photosensitive regions, and each photosensitive region is provided with at least one photosensor. The display device includes a mode recognition module, a determination module, and a brightness adjustment module. The mode recognition module is configured to identify a display mode of the display panel. The determination module is coupled to the mode recognition module, photosensors in all the photosensitive regions on the first side of the display panel, and photosensors in all the photosensitive regions on the second side of the display panel. When the display panel enters a landscape mode, if a part of the photosensors in the photosensitive regions on both the first side and the second side of the display panel are blocked, the display panel is determined to be in a false touch state, and a false touch signal is generated. The brightness adjustment module is configured to adjust the brightness of the display panel. The brightness adjustment module is coupled to the determination module. When the false touch signal is received, the brightness adjustment module keeps the brightness of the display panel unchanged. The first side and the second side of the display panel refer to the left and right sides of the display panel when it is in landscape mode, respectively.

Embodiments of the present application further disclose a non-volatile storage medium, the non-volatile storage medium has stored thereon a computer program, when the computer program is executed by a processor, the brightness control method for a display panel is implemented, a display region of the display panel is divided into a plurality of photosensitive regions arranged in an array, wherein each side of the display panel includes a plurality of photosensitive regions, and wherein there is disposed at least one photosensor in each photosensitive region. The brightness control method includes:
obtaining a display mode of the display panel;
in response to detecting that the display panel enters a landscape mode, detecting whether photosensors in the plurality of photosensitive regions disposed on a first side and a second side of the display panel are being occluded; and
in response to detecting that photosensors in a part of the photosensitive regions disposed on each of the first side and the second side of the display panel are simultaneously occluded, determining that the display panel is in a false touch state, and maintaining the brightness of the display panel unchanged.

The beneficial effects of the embodiments of the present application are as follows. In the embodiments of the present application, the determination module detects whether only part of the photosensors in the photosensitive regions on both the first side and the second side of the display panel are blocked when the display panel is in landscape mode. If only part of the photosensors in the photosensitive regions on both the first side and the second side of the display panel are blocked when the display panel is in landscape mode, it is determined that the display panel is in a false touch state and the brightness of the display panel is kept unchanged. Otherwise, normal brightness adjustment is performed, thereby avoiding incorrect brightness adjustment caused by accidental touches during the use of the display panel, which would otherwise affect the user experience.

### BRIEF DESCRIPTION OF DRAWINGS

The accompanying drawings are used to provide a further understanding of the embodiments according to the present application, and constitute a part of the specification. They are used to illustrate the embodiments according to the present application, and explain the principles of the present application in conjunction with the text description. Apparently, the drawings in the following description merely represent some embodiments of the present disclosure, and for those having ordinary skill in the art, other drawings may also be obtained based on these drawings without investing creative. In the drawings:

FIG. 1a is a schematic diagram of a display device according to an embodiment of the present application.

FIG. 1b is a schematic diagram of a display panel according to an another embodiment of the present application.

FIG. 2 is a schematic diagram of a display panel with signal lines according to an embodiment of the present application.

FIG. 3 is a schematic diagram of a display panel with a photosensor design according to an embodiment of the present application.

FIG. 4 is a schematic diagram of a switching current.

FIG. 5 is a schematic diagram of a signal line according to an embodiment of the present application.

FIG. 6 is a schematic diagram of another signal line according to an embodiment of the present application.

FIG. 7 is a partial schematic diagram of a display panel according to an embodiment of the present application.

FIG. 8 is a flowchart illustrating a brightness control method for a display panel according to an embodiment of the present application.

FIG. 9 is a schematic diagram of a display panel according to an embodiment of the present application.

FIG. 10 is a schematic diagram of a non-volatile storage medium according to an embodiment of the present application.

In the drawings: 10, display device; 100, display panel; 110, mode recognition module; 120, determination module; 130, brightness adjustment module; 140, first side of the display panel; 150, second side of the display panel; 160, color filter substrate; 161, light-shielding layer; 170, array substrate; 200, photosensitive region; 210, first photosensitive region; 211, first sub-photosensitive region; 212, second sub-photosensitive region; 213, third sub photosensitive region; 214, fourth sub photosensitive region; 220, second photosensitive region; 230, third photosensitive region; 240, fourth photosensitive region; 300, photosensor; 400, signal line; 410, sensing portion; 420, wiring portion; 500, data line; 600, scan line; 700, active switch; 800, driving circuit; 900, non-volatile storage medium; 910, computer program; 920, processor.

### DETAILED DESCRIPTION OF EMBODIMENTS

It should be understood that the terms used herein, the specific structures and functional details disclosed therein are merely representative for describing some specific embodiments, but the present application can be implemented in many alternative forms and should not be construed as being limited to only these embodiments described herein.

In addition, unless otherwise clearly specified and defined, terms "connected to", "coupled to", etc., should be understood in a broad sense. For example, it may be a fixed connection, a detachable connection, or an integral connection; it may be a mechanical connection or an electrical connection; it may be a direct connection or an indirect connection through an intermediate medium, or it may be internal communication between two elements. For those of ordinary skill in the art, the specific meanings of the above terms as used in the present application can be understood depending on specific contexts.

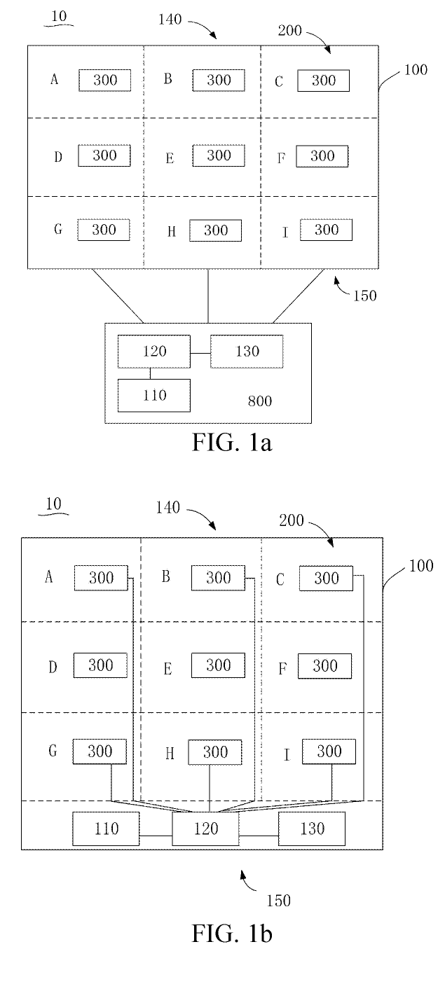

FIG. 1a is a schematic diagram of a display device according to an embodiment of the present application. As shown in FIG. 1a, the display device 10 includes a driving circuit 800 and a display panel 100. The driving circuit 800 is configured to drive the display panel 100. The display panel 100 may be a Liquid Crystal Display (LCD) panel, an Organic Light-Emitting Diode (OLED) panel, or another type of display panel, which is not limited herein.

As shown in FIG. 1a, the display region of the display panel 100 is divided into a plurality of photosensitive regions 200 arranged in an array. Each side of the display panel 100 includes multiple photosensitive regions 200. It should be noted that FIG. 1 illustrates an example in which the display region is divided into nine photosensitive regions 200 of equal size, but this does not imply that the embodiments of the present application are limited to only nine photosensitive regions 200, nor does it imply that all photosensitive regions 200 must have the same area. The specific number and sizes of the photosensitive regions 200 are determined by the characteristics of different display products and are not limited herein.

At least one photosensor 300 is disposed in each of the photosensitive regions 200. The display panel 100 includes a mode recognition module 110, a determination module 120, and a brightness adjustment module 130. As shown in FIG. 1b, the mode recognition module 110, the determination module 120, and the brightness adjustment module 130 may be set as circuit structures inside the display panel 100 or integrated as chips inside the display panel 100 and are located in the non-display area of the display panel 100. Of course, as shown in FIG. 1a, the mode recognition module 110, the determination module 120, and the brightness adjustment module 130 may be integrated in the driving circuit 800 to improve the integration degree of the chip where the driving circuit 800 is disposed.

The mode recognition module 110 is configured to identify the display mode of the display panel 100, specifically to identify whether the display screen of the display panel 100 is in a landscape state or a portrait state. The determination module 120 is coupled to the mode recognition module 110, photosensors 300 within all the photosensitive regions 200 on the first side 140 of the display panel, and photosensors 300 within all the photosensitive regions 200 on the second side 150 of the display panel. When the display panel 100 enters the landscape mode, if the photosensors 300 within a part of the photosensitive regions 200 on both the first side 140 and the second side 150 of the display panel are simultaneously blocked, the display panel 100 is determined to be in a false touch state, and a false touch signal is issued. The brightness adjustment module 130 is configured to adjust the brightness of the display panel 100. The brightness adjustment module 130 is coupled to the determination module 120. Upon receiving the false touch signal, the brightness adjustment module 130 maintains the brightness of the display panel 100 unchanged. The first side 140 and the second side 150 of the display panel respectively correspond to the left and right sides of the display panel 100 when it is in the landscape mode.

As shown in FIG. 1a, there is shown a schematic diagram of the display device in a portrait state, in which the nine photosensitive regions 200 in the display panel 100 are defined as photosensitive region A, photosensitive region B, photosensitive region C, photosensitive region D, photosensitive region E, photosensitive region F, photosensitive region G, photosensitive region H, and photosensitive region I, respectively. As a specific example of a gaming scenario, when playing games in the landscape state, the user's hands are likely to hold the two sides of the display product. At this time, the user's fingers are likely to cover photosensitive region A and photosensitive region G, or photosensitive region C and photosensitive region I. When the photosensors 300 in only photosensitive region A and photosensitive region G, or only photosensitive region C and photosensitive region I are blocked, or in other cases when one of photosensitive regions A, B, and C and one of photosensitive regions G, H, and I are blocked, it is determined as false occlusion and false touch state. At this time, the brightness of the display panel 100 is maintained at the current level.

If the photosensors 300 within all the photosensitive regions 200 on both the first side 140 and the second side 150 of the display panel are blocked, it indicates that both sides of the display panel 100 are covered in the landscape state. In the landscape state, a user may not simultaneously block both sides of the display panel 100 during viewing or gaming, as this would affect the display and prevent manipulation of the display panel 100. Therefore, when photosensors 300 within all the photosensitive regions 200 on the first side 140 and the second side 150 are blocked, it may be determined that the display panel 100 has entered a dark state area or is completely covered, rather than being in a false touch state. Accordingly, brightness adjustment can be performed.

In this embodiment of the present application, the determination module 120 detects whether, in the landscape mode, only the photosensors 300 within a part of the photosensitive regions 200 on the first side 140 and the second side 150 of the display panel 100 are simultaneously blocked. If only the photosensors 300 within a part of the photosensitive regions 200 on the first side 140 and the second side 150 of the display panel 100 are simultaneously blocked, it is determined that the display panel 100 is in a false touch state, and the brightness of the display panel 100 is maintained unchanged. Otherwise, normal brightness adjustment is performed to avoid incorrect dimming caused by false touches during use of the display panel 100, thereby improving the user experience.

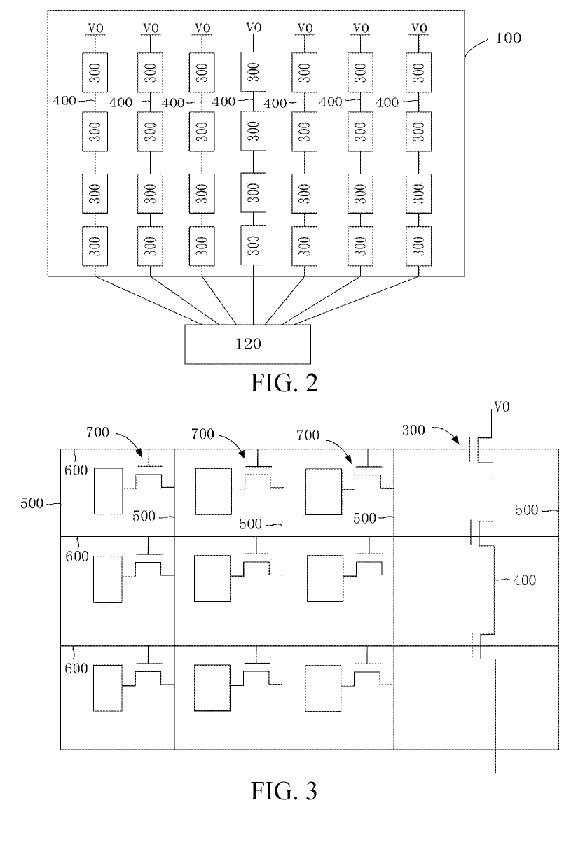

As shown in FIG. 2, as one implementation of the embodiments of the present application, the display panel 100 includes multiple signal lines 400 arranged in parallel, and the multiple signal lines 400 are evenly distributed in the display panel 100. Each signal line 400 passes through multiple photosensitive regions 200, thereby connecting multiple photosensors 300 in series. One end of the signal line 400 is coupled to a preset voltage V0 (the magnitude of the preset voltage is designed depending on the characteristics of different products). The preset voltage V0 passes through all the photosensors 300 on the corresponding signal line 400 and then is output to the determination module 120. When the display panel 100 enters the landscape mode, if the brightness adjustment module 130 receives a change in the preset voltage V0 output from a part of the signal lines 400, it is determined that the display panel 100 is in a false touch state.

The photosensor 300 outputs different current signals when sensing light and when being occluded. This implementation connects the photosensors 300 in a row or column in series. The determination module 120 detects and analyzes the signals output from all signal lines 400, identifies the signal lines 400 corresponding to occluded photosensors 300, then further analyzes which photosensitive regions 200 are occluded, determines whether the conditions for a false touch state are met, and accordingly notifies the brightness adjustment module 130 to adjust the brightness or maintain the current brightness. Moreover, this implementation helps reduce the number of wiring lines and lowers the computational demands on the determination module 120.

In other implementations, each photosensor 300 is individually coupled to the determination module 120. The determination module 120 identifies the status of each photosensor 300 and, based on the positions of the occluded photosensors 300, determines whether the display panel 100 is in a false touch state.

As shown in FIG. 3, the display panel 100 includes multiple data lines 500 and multiple scan lines 600 arranged in a crisscross pattern. The multiple data lines 500 and multiple scan lines 600 divide the display panel 100 into an array of pixels. The display panel 100 further includes multiple active switches 700 configured to drive the pixels.

Moreover, in this implementation, each photosensor 300 is a thin-film transistor, and the multiple photosensors 300 are formed together with the multiple active switches 700 in the same manufacturing procedure, thereby reducing the additional cost of fabricating the photosensors 300. Each signal line 400 is arranged parallel to the data line 500. The source and drain of adjacent photosensors 300 on the same signal line 400 are connected. The gates of the photosensor 300 and the active switch 700 in the same row are coupled to the same scan line 600. Moreover, the types of the photosensor 300 and the active switch 700 are different. That is, when the active switch 700 is an N-type MOS transistor, the photosensor 300 is a P-type MOS transistor; and when the active switch 700 is a P-type MOS transistor, the photosensor 300 is an N-type MOS transistor.

Through the above design, the control wiring for the photosensors 300 is omitted, further reducing the wiring amount in the display panel 100 and avoiding a decrease in aperture ratio. Moreover, the photosensor 300 and the active switch 700 are of different types, so when driving the photosensor 300, the driving signal does not interfere with the active switch 700; likewise, when driving the active switch 700, the driving signal does not interfere with the photosensor 300. The driving signal of the photosensor 300 may be output when scanning other rows of pixels, or output during the scanning of blank scan lines 600, or output in the interval between two adjacent frames. Moreover, in other implementations, the photosensor 300 may not be designed as a thin-film transistor and may be a photodiode or other types. Alternatively, the photosensor 300 may be designed as a thin-film transistor but not formed synchronously with the active switch 700, depending on actual circumstances.

As shown in FIG. 4, in this implementation, photogenerated carriers affect the switching current of the thin-film transistor. Since the output end of each signal line 400 is coupled to the determination module 120, the determination module 120 detects a normal leakage current magnitude P1 before illumination or occlusion, and a leakage current magnitude P2 after illumination or occlusion. When a position corresponding to a certain signal line 400 is occluded, the light intensity changes, causing the leakage current of the photosensor 300 connected in series thereto to change, and the determination module 120 obtains a current change ΔP = P1 - P2. By monitoring ΔP to determine the change in light intensity, it is further analyzed whether the display panel 100 is in a false touch state.

In this implementation, the scan line 600 coupled to the photosensor 300 outputs a scan signal during the scan phase of each frame, and outputs a sensing signal in the adjacent frame. The scan signal is configured to turn on the corresponding active switches 700. The sensing signal is configured to turn on the corresponding photosensor 300. The scan lines 600 that are not coupled to any photosensor 300 output only scan signals.

During normal display, when a frame ends, the driving circuit 800 outputs a reset signal to reset the scan signals. At this time, all photosensors 300 on each signal line 400 are turned on. The determination module 120 can then monitor the current changes of all signal lines 400, assess the changes in light intensity above the screen, and determine whether a false occlusion has occurred, thereby performing correct brightness adjustment. Through the above design, all occlusion locations can be identified simultaneously, thereby improving recognition accuracy and efficiency.

In some implementations, the display panel 100 adopts a touch panel, and the signal lines 400 are redundant touch lines, that is, touch lines not coupled to touch sensors, or touch lines not involved in the touch function. Since a touch panel may design extra touch lines in advance as spares, this implementation utilizes the redundant touch lines as signal lines 400 for transmitting photosensor signals, thereby further reducing the amount of wiring in the display panel 100.

In this implementation, the size of each photosensor 300 may also be designed depending on the characteristics of different products; this implementation does not impose any limitation on this. However, the principle is to maximize the aspect ratio of the photosensor 300 and increase the thickness of the semiconductor layer within the photosensor 300, so as to improve the photosensitivity of the photosensor 300 as much as possible.

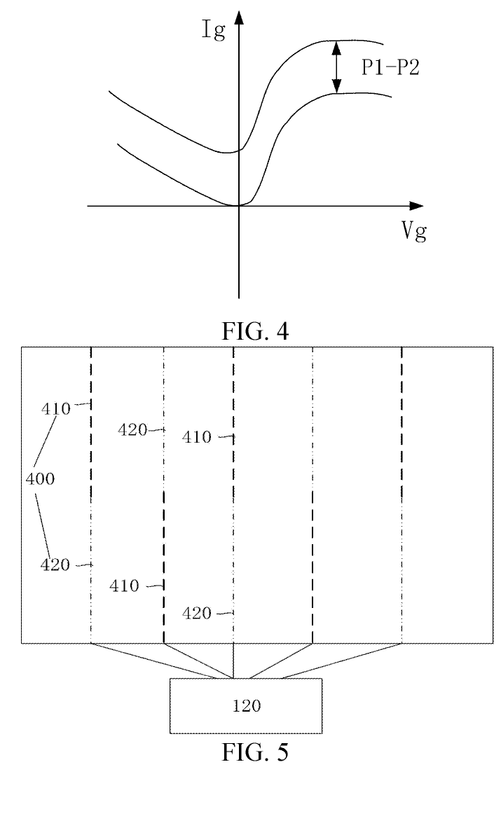

As a further implementation, as shown in FIG. 5, each signal line 400 is divided into two portions, namely the signal line 400 is divided into a series-connected sensing portion 410 and wiring portion 420. All photosensors 300 on the signal line 400 are only connected in series on the sensing portion 410. The sensing portions 410 and wiring portions 420 of adjacent signal lines 400 are arranged alternately (interleaved). That is, the sensing portion 410 of the first signal line 400 is at the top and the wiring portion 420 is at the bottom; the sensing portion 410 of the second signal line 400 is at the bottom and the wiring portion 420 is at the top; the sensing portion 410 of the third signal line 400 is at the top and the wiring portion 420 is at the bottom, and so on alternately.

Taking the landscape mode gaming scenario as an example, if a finger covers the area from the first signal line 400 to the tenth signal line 400, the light intensity in this area weakens, causing the leakage current of each corresponding thin-film transistor to change in magnitude, and the determination module 120 will receive a ΔP signal. However, there are gaps between the fingers, so the first to tenth signal lines 400 theoretically will not simultaneously detect current changes. If the determination module 120 simultaneously receives feedback signals from the first to tenth signal lines 400, it determines that it is not a false occlusion and thus performs brightness adjustment. If the determination module 120 does not simultaneously monitor feedback signals from the first to tenth signal lines 400, for example, no feedback is received from the sixth signal line 400, it is determined to be a false occlusion in a gaming scenario, and therefore no brightness adjustment is made, and the screen brightness is kept unchanged. With the corresponding design illustrated in FIG. 4, the number of photosensors 300 is first reduced, thereby lowering the cost. Secondly, when signal changes occur on multiple signal lines 400 within a region, it indicates that the photosensors 300 on both sides of that region are blocked in the landscape state, thereby recognizing a false occlusion. This requires no complex computation—only detection of signal changes on the signal lines 400 is needed—thus reducing the difficulty for the determination module 120 to determine a false touch state.

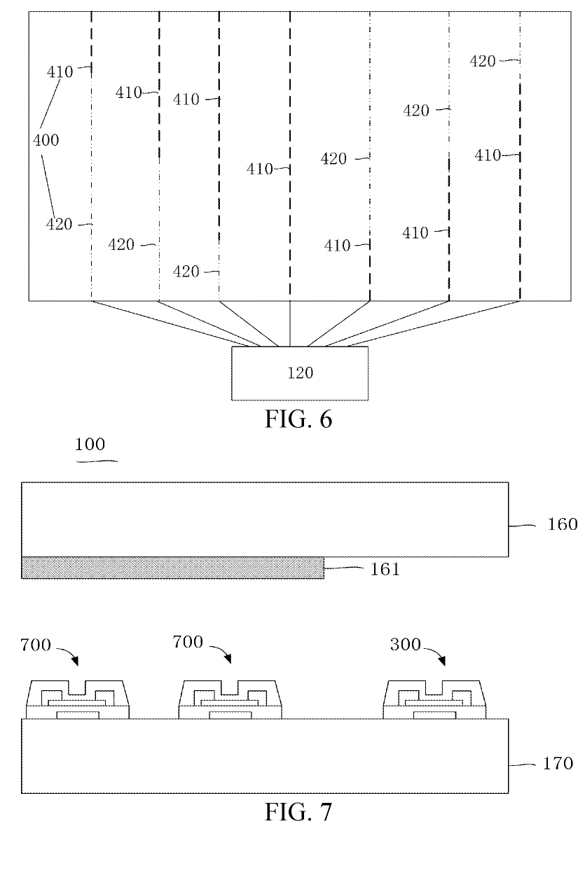

As another further implementation, as shown in FIG. 6, each signal line 400 is divided into a sensing portion 410 and a wiring portion 420 connected in series. All the photosensors 300 on the signal line 400 are connected in series only within the sensing portion 410. In the direction from the first signal line 400 to the last signal line 400, the length of the sensing portion 410 first increases and then decreases. In each of the first half of the signal lines 400, the sensing portion 410 is located on the side of the wiring portion 420 that faces away from the determination module 120. In each of the second half of the signal lines 400, the sensing portion 410 is located between the wiring portion 420 and the determination module 120.

As a specific example of this implementation, if there are only seven signal lines 400 in total, the length of the sensing portion 410 in the first signal line 400 is one fourth of the total length of the signal line 400, the length of the sensing portion 410 in the second signal line 400 is one half of the total length of the signal line 400, the length of the sensing portion 410 in the third signal line 400 is three fourths of the total length of the signal line 400, the length of the sensing portion 410 in the fourth signal line 400 is equal to the total length of the signal line 400, the length of the sensing portion 410 in the fifth signal line 400 is one fourth of the total length of the signal line 400, the length of the sensing portion 410 in the sixth signal line 400 is one half of the total length of the signal line 400, the length of the sensing portion 410 in the seventh signal line 400 is three fourths of the total length of the signal line 400. Moreover, of the first, the second, and the third signal lines 400, the sensing portion 410 is disposed on the side of the wiring portion 420 that faces away from the determination module 120. Of the fifth, the sixth, and the seventh signal lines 400, the sensing portion 410 is disposed between the wiring portion 420 and the determination module 120. By adopting the design corresponding to FIG. 5, the number of photosensors 300 can also be reduced, and the accuracy of the photosensitive function can be improved.

Through the above design, the problem of erroneous brightness adjustment caused by false occlusion of the photosensor(s) 300 in different products and usage scenarios is solved, thereby improving the user experience.

As shown in FIG. 7, in the embodiments of the present application, when the display panel 100 is a liquid crystal panel, the photosensors 300 and the active switches 700 are both disposed on the array substrate 170. A light-shielding layer 161 is disposed on the color filter substrate 160 to cover the active switches 700, so as to prevent the active switches 700 from generating a leakage current that may affect the display. The color filter substrate 160 is not provided with a structure that blocks the photosensors 300, or the light-shielding layer 161 above the photosensors 300 is opened so that external ambient light can irradiate the photosensors 300.

Correspondingly, as shown in FIG. 8, the embodiments of the present application further disclose a brightness control method for a display panel, which is configured to control the brightness of the above-described display panels 100. The brightness control method includes the following operations:
S1: obtaining a display mode of the display panel;
S2: when it is detected that the display panel is in a landscape mode, simultaneously detecting whether the photosensors in the photosensitive regions located on the first side and the second side of the display panel are being blocked; and
S3: when it is detected that the photosensors within a part of the photosensitive regions on both the first side and the second side of the display panel are simultaneously being blocked, determining that the display panel is in a false touch state and maintaining the brightness of the display panel unchanged.

By adopting the above design, erroneous brightness adjustment of the display panel caused by false touch during use can be avoided, thereby improving the user experience.

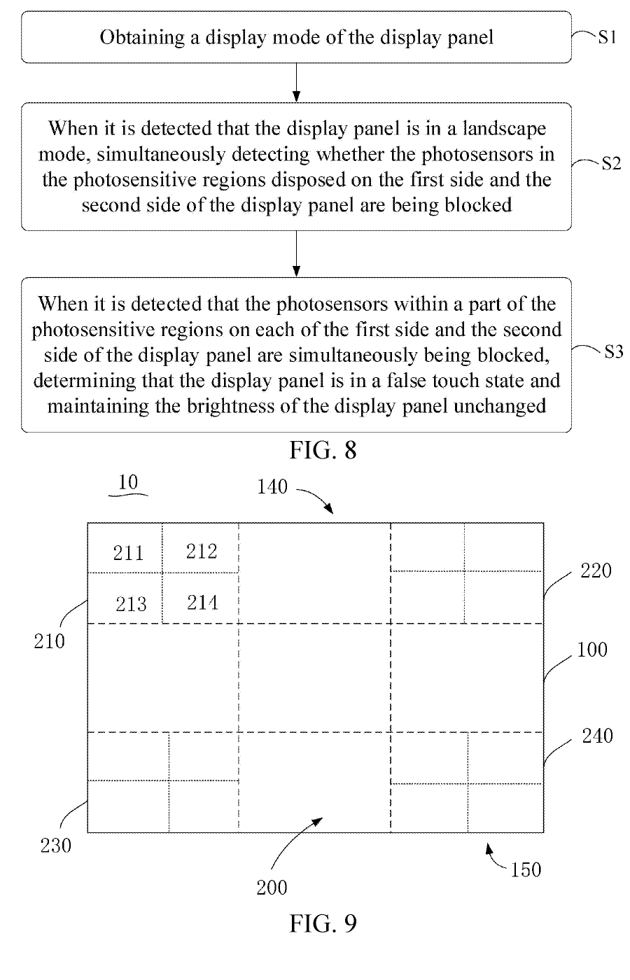

Furthermore, in some embodiments, as shown in FIG. 9, the photosensitive regions 200 located at both ends of the first side 140 of the display panel are respectively defined as a first photosensitive region 210 and a second photosensitive region 220, and the photosensitive regions 200 located at both ends of the second side 150 of the display panel are respectively defined as a third photosensitive region 230 and a fourth photosensitive region 240. Each of the first photosensitive region 210, the second photosensitive region 220, the third photosensitive region 230, and the fourth photosensitive region 240 includes at least four sub-photosensitive regions arranged in an array, and at least one photosensor 300 is disposed within each sub-photosensitive region.

At this time, in operation S3, when the photosensors 300 within a part of the sub-photosensitive regions of the first photosensitive region 210 or the second photosensitive region 220 are blocked, and simultaneously the photosensors 300 within a part of the sub-photosensitive regions of the third photosensitive region 230 or the fourth photosensitive region 240 are blocked, the display panel 100 is determined to be in a false touch state, and the brightness of the display panel 100 is maintained unchanged.

In the above embodiment, to enhance the accuracy of the algorithm in determining false occlusion, taking the gaming application scenario as an example, the four regions of the first photosensitive region 210, the second photosensitive region 220, the third photosensitive region 230, and the fourth photosensitive region 240 are further subdivided into finer partitions. Taking the first photosensitive region 210 as an example, the first photosensitive region 210 is divided into the first sub-photosensitive region 211, the second sub-photosensitive region 212, the third sub-photosensitive region 213, and the fourth sub-photosensitive region 214. When playing games in the landscape mode, the fingers may cover the screen, but gaps between fingers mean the entire first photosensitive region 210 is not completely covered. For example, when the first photosensitive region 210 is covered, more particularly the first sub-photosensitive region 211, the second sub-photosensitive region 212, and the third sub-photosensitive region 213 all detect occlusion, but the fourth sub-photosensitive region 214 remains uncovered, then it is determined as false occlusion, and no brightness adjustment is performed. If all four sub-regions in the first photosensitive region 210 are covered, and other regions also detect occlusion signals, it is determined as a true occlusion, and brightness adjustment would be performed.

In some embodiments, when it is detected that the photosensors within all the photosensitive regions on the first side and the second side of the display panel are blocked, it is further detected whether the photosensors within all the photosensitive regions on the third side and the fourth side of the display panel are also blocked. If the photosensors within at least a part of the photosensitive regions on the third side and the fourth side of the display panel are not blocked, the display panel is determined to be in a false touch state, and the brightness of the display panel is maintained unchanged. The third side and the fourth side of the display panel correspond to the upper side and lower side of the display panel when the display panel is in landscape mode, respectively. When, in some accidental circumstances, the user holds the display panel by both sides in landscape mode without operating the display panel, the two sides of the display panel are blocked. However, in this case, brightness adjustment is not needed. At this time, the upper and lower sides of the display panel in landscape mode can be further identified to determine whether the entire display panel is blocked. This embodiment further considers the false touch problem caused by accidental situations, thereby improving the user experience.

Of course, in other embodiments, false touch state may also be determined through other detections, which are not specifically exemplified herein.

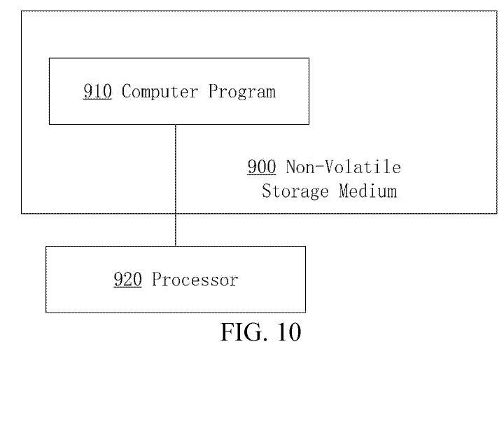

As shown in FIG. 10, embodiments of the present application also provide a non-volatile storage medium, the non-volatile storage medium has stored thereon a computer program. When the computer program is executed by a processor, the brightness control method for a display panel as described above is implemented.

It should be noted that the limitations of the various steps or operations involved in this solution are not to be interpreted to limit the order of the steps or operations, under the premise of not affecting the implementation of the specific solution. The steps or operations written earlier can be executed first, or later, or even at the same time with the steps or operations written later. The solutions of different embodiments may be combined and applied, provided that there is no conflict between them. As long as this solution can be implemented, it should be regarded as falling in the scope of protection of this application.

The foregoing is a further detailed description of the present application with reference to some specific optional implementations, but it cannot be determined that the specific implementation of the present application is limited to these implementations. For those having ordinary skill in the technical field to which the present application pertains, several deductions or substitutions may be made without departing from the concept of the present application, and all these deductions or substitutions should be regarded as falling within the scope of protection of the present application.

What is claimed is:

1. A display panel, wherein a display region of the display panel is divided into a plurality of photosensitive regions that are arranged in an array, wherein each side of the display panel comprises a plurality of photosensitive regions, and each of the plurality of photosensitive regions comprises at least one photosensor; wherein the display panel comprises:
a mode recognition module, configured to identify a display mode of the display panel;
a determination module, coupled to the mode recognition module, photosensors within all photosensitive regions on a first side of the display panel, and photosensors within all photosensitive regions on a second side of the display panel; wherein in response to detecting that the display panel enters a landscape mode and that photosensors within a part of the photosensitive regions on each of the first side and the second side of the display panel are occluded simultaneously, the determination module is configured to determine that the display panel is in a false touch state and generate a false touch signal; and
a brightness adjustment module, configured to adjust a brightness of the display panel, the brightness adjustment module being coupled to the determination module and configured to maintain the brightness of the display panel unchanged upon receiving the false touch signal;
wherein the first side and the second side of the display panel correspond to a left side and a right side of the display panel, respectively, when the display panel is in the landscape mode.

2. The display panel as recited in claim 1, wherein the display panel comprises a plurality of signal lines arranged in parallel, wherein each of the plurality of signal lines passes through a plurality of photosensitive regions to serially connect a plurality of corresponding photosensors;
wherein one end of each of the plurality of signal lines is coupled to a preset voltage, the preset voltage passing through all the corresponding photosensors on the signal line and being output to the determination module;
wherein in response to detecting that the display panel enters the landscape mode and that the preset voltage received by the brightness adjustment module and output from a part of the plurality of signal lines changes, the display panel is determined to be in the false touch state.

3. The display panel as recited in claim 1, wherein each of the plurality of photosensors is individually electrically coupled to the determination module.

4. The display panel as recited in claim 2, wherein the display panel comprises a plurality of data lines and a plurality of scan lines arranged in a crisscross pattern, the plurality of data lines and the plurality of scan lines dividing the display panel into a plurality of pixels that are distributed in an array, the display panel further comprising a plurality of active switches configured to drive the plurality of pixels;
wherein each of the plurality of photosensors is a thin film transistor (TFT), and the plurality of photosensors and the plurality of active switches are formed through a same manufacturing procedure; wherein each of the plurality of signal lines is arranged parallel to the plurality of data lines; wherein a source and a drain of adjacent photosensors on each same signal line are electrically connected; wherein gates of the plurality of photosensors and the plurality of active switches in a same row are coupled to a same scan line; and wherein each of the plurality of photosensors is of a different type than each of the plurality of active switches.

5. The display panel as recited in claim 4, wherein each of the plurality of active switches is an N-type MOS transistor, and wherein each of the plurality of photosensors is a P-type MOS transistor.

6. The display panel as recited in claim 4, wherein each of the plurality of active switches is a P-type MOS transistor, and wherein each of the plurality of photosensors is an N-type MOS transistor.

7. The display panel as recited in claim 4, wherein each scan line coupled to the corresponding one or more photosensors is configured to output a scan signal during a scan phase of each frame and output a sensing signal during an adjacent frame;
wherein the scan signal is configured to turn on the corresponding plurality of active switches, the sensing signal is configured to turn on the corresponding one or more photosensors; wherein each scan line not coupled to any photosensors is configured to output only the scan signal.

8. The display panel as recited in claim 4, wherein the display panel comprises a liquid crystal panel;
wherein the plurality of photosensors and plurality of active switches are disposed on an array substrate of the liquid crystal panel;
wherein the display panel further comprises a light-shielding layer that is disposed on the color filter substrate of the liquid crystal panel and that is configured to occlude the plurality of active switches.

9. The display panel as recited in claim 2, wherein each of the plurality of signal lines is divided into a sensing portion and a wiring portion that are connected in series, and wherein all the photosensors on each of the plurality of signal lines are serially disposed only on the sensing portion;
wherein the sensing portion and the wiring portion of every two adjacent signal lines are arranged in a staggered manner.

10. The display panel as recited in claim 2, wherein each of the plurality of signal lines is divided into a sensing portion and a wiring portion that are connected in series, and wherein all the photosensors on each of the plurality of signal lines are serially disposed only on the sensing portion;
wherein in a direction from a first signal line to a last signal line, a length of the sensing portion first increases and then decreases;
wherein of each signal line in a first half of the plurality signal lines, the corresponding sensing portion is disposed on a side of the corresponding wiring portion facing away from the determination module; and
wherein of each signal line in a second half of the plurality signal lines, the corresponding sensing portion is disposed between the corresponding wiring portion and the determination module.

11. The display panel as recited in claim 10, wherein the display panel comprises seven signal lines, comprising a first signal line, a second signal line, a third signal line, a fourth signal line, a fifth signal line, a sixth signal line, and a seventh signal line;
wherein a length of the sensing portion in the first signal line is one quarter of a length of the first signal line; a length of the sensing portion in the second signal line is one half of a length of the second signal line; a length of the sensing portion in the third signal line is three quarters of a length of the third signal line; a length of the sensing portion in the fourth signal line is equal to a length of the fourth signal line; a length of the sensing portion in the fifth signal line is one quarter of a length of the fifth signal line; a length of the sensing portion in the sixth signal line is one half of a length of the sixth signal line; and a length of the sensing portion in the seventh signal line is three quarters of a length of the seventh signal line.

12. The display panel as recited in claim 11, wherein of each of the first signal line, the second signal line, and the third signal line, the corresponding sensing portion is disposed on a side of the corresponding wiring portion facing away from the determination module; and of each of the fifth signal line, the sixth signal line, and the seventh signal line, the corresponding sensing portion is disposed between the corresponding wiring portion and the determination module.

13. The display panel as recited in claim 2, wherein the display panel comprises a touch panel, and wherein each of the plurality of signal lines is a touch line in the touch panel that does not participate in a touch function.

14. A brightness control method for a display panel, configured to control a brightness of the display panel, wherein a display region of the display panel is divided into a plurality of photosensitive regions arranged in an array, wherein each side of the display panel comprises a plurality of photosensitive regions, and wherein there is disposed at least one photosensor in each photosensitive region, the brightness control method comprising:
obtaining a display mode of the display panel;
in response to detecting that the display panel enters a landscape mode, detecting whether photosensors in the plurality of photosensitive regions disposed on a first side and a second side of the display panel are being occluded; and
in response to detecting that photosensors in a part of the photosensitive regions disposed on each of the first side and the second side of the display panel are simultaneously occluded, determining that the display panel is in a false touch state, and maintaining the brightness of the display panel unchanged.

15. The brightness control method as recited in claim 14, wherein photosensitive regions disposed at both ends of the first side of the display panel are respectively defined as a first photosensitive region and a second photosensitive region, and wherein photosensitive regions disposed at both ends of the second side of the display panel are respectively defined as a third photosensitive region and a fourth photosensitive region;
wherein the first photosensitive region, the second photosensitive region, the third photosensitive region, and the fourth photosensitive region each comprise at least four sub-photosensitive regions arranged in an array, and each sub-photosensitive region comprises at least one photosensor;
wherein the operation of determining that the display panel is in the false touch state and maintaining the brightness of the display panel unchanged in response to detecting that the photosensors in a part of the photosensitive regions disposed on each of the first side and the second side of the display panel are simultaneously occluded comprises: in response to detecting that photosensors in a part of the sub-photosensitive regions of the first photosensitive region or the second photosensitive region are occluded and that photosensors in a part of the sub-photosensitive regions of the third photosensitive region or the fourth photosensitive region are simultaneously occluded, determining that the display panel is in the false touch state, and maintaining the brightness of the display panel unchanged.

16. The brightness control method as recited in claim 14, further comprising:
in response to that the photosensors in all the photosensitive regions disposed on the first side and the second side of the display panel are occluded, further detecting the photosensors in the photosensitive regions disposed on the third side and the fourth side of the display panel; and
in response to detecting that the photosensors in at least a part of the photosensitive regions on the third side and the fourth side of the display panel are not occluded, determining that the display panel is in the false touch state, and maintaining the brightness of the display panel unchanged;
wherein the third side and the fourth side of the display panel correspond to an upper side and a lower side of the display panel, respectively, when the display panel is in the landscape mode.

17. A display device, comprising a driving circuit and a display panel, wherein the driving circuit is configured to drive the display panel, wherein a display region of the display panel is divided into a plurality of photosensitive regions that are arranged in an array, wherein each side of the display panel comprises a plurality of photosensitive regions, and each of the plurality of photosensitive regions comprises at least one processor; wherein the display device comprises:
a mode recognition module, configured to identify a display mode of the display panel;
a determination module, coupled to the mode recognition module, photosensors within all photosensitive regions on a first side of the display panel, and photosensors within all photosensitive regions on a second side of the display panel; wherein in response to detecting that the display panel enters a landscape mode and that photosensors within a part of the photosensitive regions on each of the first side and the second side of the display panel are occluded simultaneously, the determination module is configured to determine that the display panel is in a false touch state and generate a false touch signal; and
a brightness adjustment module, configured to adjust a brightness of the display panel, the brightness adjustment module being coupled to the determination module and configured to maintain the brightness of the display panel unchanged upon receiving the false touch signal;
wherein the first side and the second side of the display panel correspond to a left side and a right side of the display panel, respectively, when the display panel is in the landscape mode.

18. The display device as recited in claim 17, wherein
the display panel comprises a plurality of signal lines arranged in parallel, wherein each of the plurality of signal lines passes through a plurality of photosensitive regions to serially connect a plurality of corresponding photosensors;
wherein one end of each of the plurality of signal lines is coupled to a preset voltage, the preset voltage passing through all the corresponding photosensors on the signal line and being output to the determination module;
wherein in response to detecting that the display panel enters the landscape mode and that the preset voltage received by the brightness adjustment module and output from a part of the plurality of signal lines changes, the display panel is determined to be in the false touch state.

19. The display device as recited in claim 18, wherein
the display panel comprises a plurality of data lines and a plurality of scan lines arranged in a crisscross pattern, the plurality of data lines and the plurality of scan lines dividing the display panel into a plurality of pixels that are distributed in an array, the display panel further comprising a plurality of active switches configured to drive the plurality of pixels;
wherein each of the plurality of photosensors is a thin film transistor (TFT), and the plurality of photosensors and the plurality of active switches are formed through a same manufacturing procedure; wherein each of the plurality of signal lines is arranged parallel to the plurality of data lines; wherein a source and a drain of adjacent photosensors on each same signal line are electrically connected; wherein gates of the plurality of photosensors and the plurality of active switches in a same row are coupled to a same scan line; and wherein each of the plurality of photosensors is of a different type than each of the plurality of active switches.

20. The display device as recited in claim 18, wherein each scan line coupled to the corresponding one or more photosensors is configured to output a scan signal during a scan phase of each frame and output a sensing signal during an adjacent frame;
wherein the scan signal is configured to turn on the corresponding plurality of active switches, the sensing signal is configured to turn on the corresponding one or more photosensors; wherein each scan line not coupled to any photosensors is configured to output only the scan signal.
